(19) United States
(12) Patent Application Publication
(10) Pub. No.: US 2009/0196529 A1
(43) Pub. Date: Aug. 6, 2009

(54) SYSTEM AND METHOD FOR CONTENT SENSITIVE DOCUMENT PROCESSING

(76) Inventors: William Su, Riverside, CA (US); Hongfeng Wei, Cerritos, CA (US); Jianxin Wang, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/026,964

(22) Filed: Feb. 6, 2008

(51) Int. Cl. G06K 9/54

(52) U.S. Cl. 382/306

(57) ABSTRACT

The subject application is directed to a system and method for content-sensitive document processing. First, at least one electronic document is received. A document processing device then retrieves content data from an associated data storage. The content data suitably corresponds to acceptable content associated with the document processing device. The document processing device then compares at least a portion of the electronic document with the received content data. Processing of the portion of the received electronic document is then controlled in accordance with the results of the comparison.

### BACKGROUND OF THE INVENTION

The subject application is directed generally to content-based control of document processing operations, and is particularly suited to control of document processing operations in locations concerned about processing of unsuitable materials.

Document processing machines include copiers, printers, facsimile machines, as well as devices having more than one function, which are referred to as multifunction peripherals or MFPs. Given the flexibility of document reproduction, transmission or rendering operations performable by today's document processing devices, there is substantial opportunity for use in reproduction, output or transmission of content that has been deemed by a device administrator to be inappropriate.

By way of example, inappropriate content may include pornography or profanity. Such content may also be directed to areas of violence, intolerance, militant extremism, gambling, drug use, or any immoral or illegal behavior. Some institutions are particularly sensitive to particular content, such as schools, corporations or government facilities, such as content which is confidential, proprietary, or other types of data that should not be publicly disseminated. Also of concern are devices that are publicly available or viewable, such that others may be exposed to their use relative to undesirable content.

### SUMMARY OF THE INVENTION

In accordance with one embodiment of the subject application, there is provided a system and method for content-based control of document processing operations.

Further, in accordance with one embodiment of the subject application, there is provided a system and method for control of document processing operations in locations concerned about processing of unsuitable materials.

Still further, in accordance with one embodiment of the subject application, there is provided a system for content-sensitive document processing. The system comprises means adapted for receiving at least one electronic document and means adapted for retrieving content data from an associated data storage, which content data corresponds to acceptable content associated with the at least one document processing device. The system also comprises comparison means adapted for comparing at least a portion of the at least one electronic document with received content data. The system further comprises control means adapted for controlling processing of at least a portion of a received electronic document by the document processing system in accordance with an output of the comparison means.

In one embodiment of the subject application, the system also comprises means adapted for masking at least a portion of the received electronic document by the document processing system in accordance with an output of the control means.

In another embodiment of the subject application, the system also includes means adapted for receiving overlay data. In such embodiment, the masking means includes means adapted for masking the at least a portion of the received electronic document with received overlay data. In a preferred embodiment, the overlay data includes data adapted for generating indicia representative of altered document processing.

In yet another embodiment of the subject application, the electronic document includes encoded image data and the content data includes preselected string data. In such embodiment, the system further comprises optical character recognition means adapted for generating encoded character data from received image data. In addition, the comparison means includes means adapted for comparing encoded character data with the preselected string data.

In another embodiment of the subject application, the electronic document includes encoded image data, and the content data includes data corresponding to acceptability of encoded image data.

Still further, in accordance with one embodiment of the subject application, there is provided a method for content-sensitive document processing in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for content-sensitive document processing according to one embodiment of the subject application;

FIG. 2 is a block diagram illustrating device hardware for use in the system for content-sensitive document processing according to one embodiment of the subject application;

FIG. 3 is a functional diagram illustrating the device for use in the system for content-sensitive document processing according to one embodiment of the subject application;

FIG. 4 is a block diagram illustrating controller hardware for use in the system for content-sensitive document processing according to one embodiment of the subject application;

FIG. 5 is a functional diagram illustrating the controller for use in the system for content-sensitive document processing according to one embodiment of the subject application;

FIG. 6 is a flowchart illustrating a method for content-sensitive document processing according to one embodiment of the subject application; and

FIG. 7 is a flowchart illustrating a method for content-sensitive document processing according to one embodiment of the subject application.

### DETAILED DESCRIPTION OF THE PREFERRED EMBODIMENT

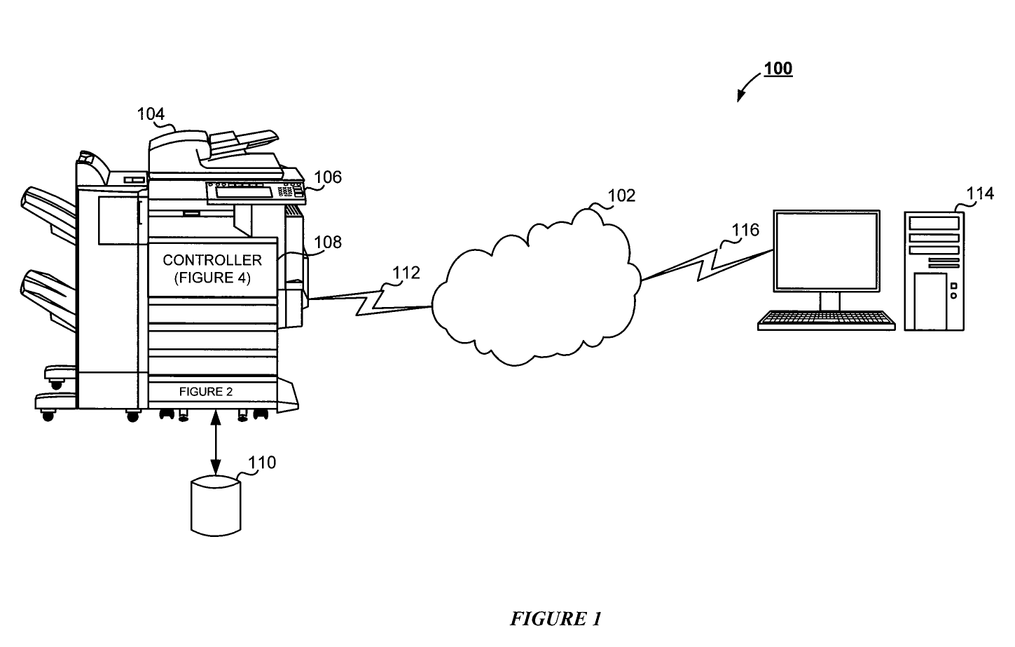

The subject application is directed to a system and method for content-sensitive document processing. In particular, the subject application is directed to a system and method for content-based control of document processing operations. More particularly, the subject application is directed to a system and method for control of document processing operations in locations concerned about processing of unsuitable materials. It will become apparent to those skilled in the art that the system and method described herein are suitably adapted to a plurality of varying electronic fields employing content-sensitive controls, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for content-sensitive document processing in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

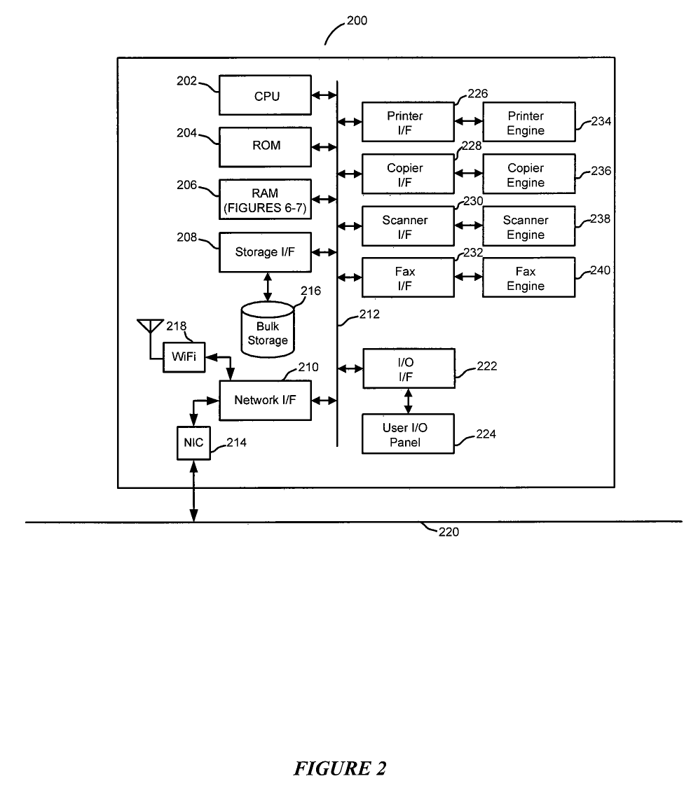

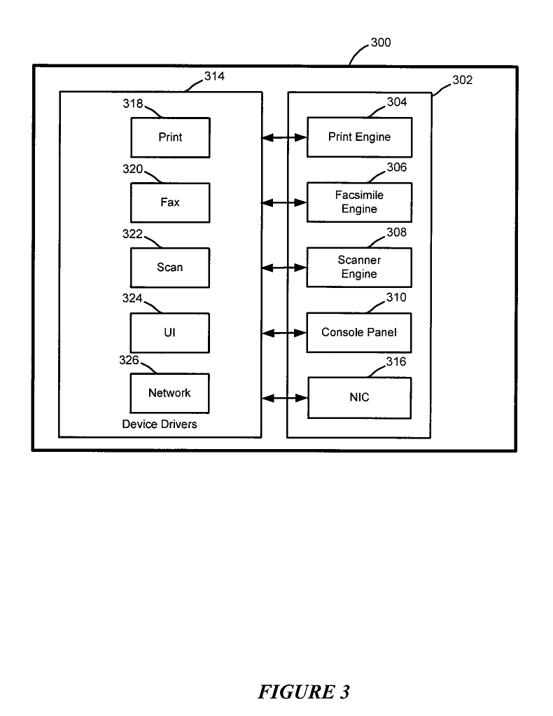

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

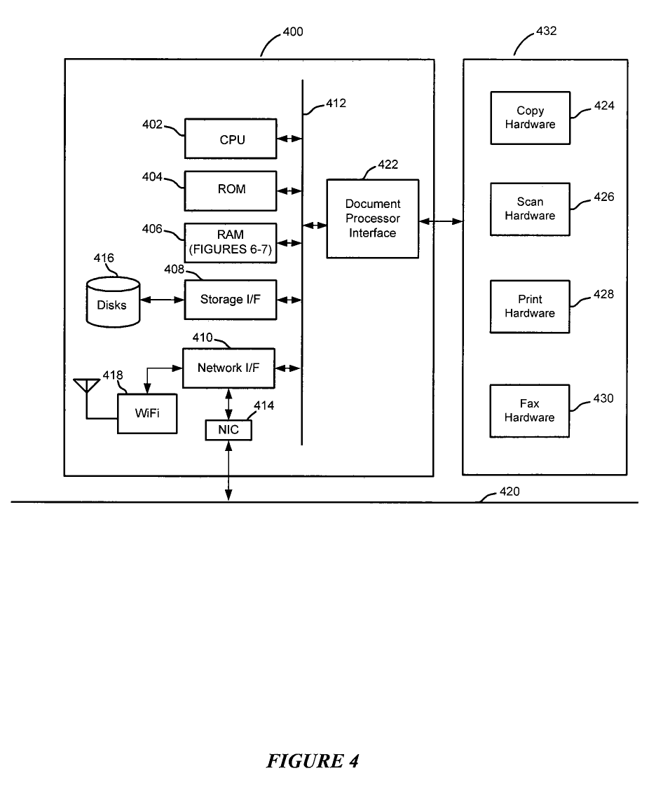

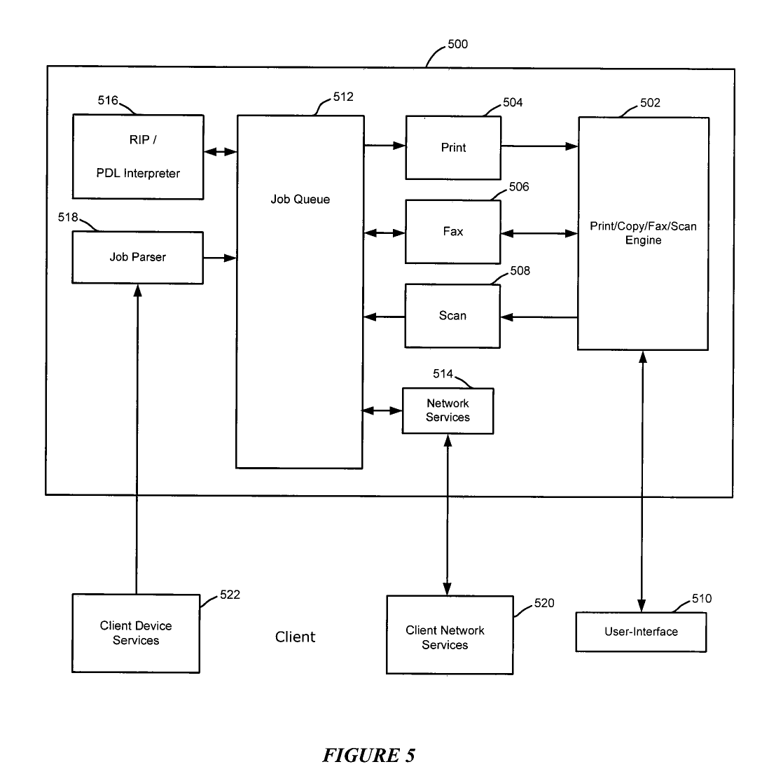

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for content-sensitive document processing of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In one such embodiment of the subject application, the data storage device 110 includes an electronic database, containing content data unsuitable for the environment in which the document processing device 104 is located. For example and without limitation, when the document processing device 104 is located in a middle school or high school environment, unsuitable content data stored in the database on the data storage device 110 includes violence, pornography, illicit behaviors, profanity, and the like, set by a school administrator as being unacceptable for output by the associated document processing device 104. In an office setting, the unacceptable content is capable of including confidential or proprietary information, such that any documents containing preselected confidential or proprietary information, as defined by the administrator, will be deemed unacceptable for output by the associated document processing device 104.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable device 200, (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable functionality of the document processing device, (shown in FIG. 1 as the document processing device 104), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404, which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by the processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which include the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a job parser 518, which job parser suitably functions to receive print job language files from an external device, such as client device services 522. The client device services 522 suitably include printing, facsimile transmission, or other suitable input of an electronic document for which handling by the controller function 500 is advantageous. The job parser 518 functions to interpret a received electronic document file and relay it to the job queue 512 for handling in connection with the afore-described functionality and components.

In operation, at least one electronic document is first received. Content data is then retrieved from an associated data storage, with the content data corresponds to acceptable content associated with at least one document processing device. At least a portion of the electronic document is then compared with the received content data. Processing of the portion of the received electronic document is then controlled in accordance with the results of the comparison.

In accordance with one example embodiment of the subject application, a document processing request is received from an associated user inclusive of an electronic document for processing by the document processing device 104. It will be appreciated by those skilled in the art that the electronic document is capable of being received by the document processing device 104 via a scanning operation, a portable storage medium, a network storage (not shown), a communication from the user device 114, or the like. The skilled artisan will further appreciate that the received electronic document is capable of including text, images, graphics, photographs, or any combination thereof. The received electronic document is then converted, as will be appreciated by those skilled in the art, into image data. According to one embodiment of the subject application, the electronic document includes encoded image data, thereby negating the necessity of converting the electronic document to image data.

Content data is then retrieved from the data storage device 110 by the controller 108 or other suitable component associated with the document processing device 104. The content data corresponds to appropriate document content for output by the document processing device 104. Preferably, an administrator or other authority sets acceptable content and unacceptable content of electronic documents associated with the document processing device 104. That is, the administrator determines the type of content, e.g. confidential or proprietary data, pornography, violence, profanity, immoral, illegal, or other such content, that is to be restricted, i.e. deemed unacceptable, and the content that is acceptable. In accordance with one embodiment of the subject application, the type of content of the electronic document dictates whether or not the document processing device 104 is allowed to perform a requested document processing operation, dictates a modification to the electronic document with respect to the unacceptable content, or a suitable combination thereof. Stated another way, the administrator defines words and images, i.e. content data, that are unsuitable for the environment in which the document processing device 104 is located, e.g. middle school, high school, library, office, etc., that are stored in a database on the data storage device 110 coupled to the document processing device 104. It will be appreciated by those skilled in the art that the content data is capable of including, for example and without limitation, preselected string data, or the like.

Encoded character data is then generated from the image data by the controller 108 or other suitable component associated with the document processing device 104. According to one embodiment of the subject application, the encoded character data is generated via the performance of optical character recognition or image recognition on the image data, as will be appreciated by those skilled in the art. In such an embodiment, the optical character recognition engine, e.g. controller 108, recognizes the text and/or image regions of the received electronic document. The encoded character data is then compared to preselected string data to determine whether the received electronic document is acceptable. That is, each word and/or image in the document, as embodied by the encoded character data, is compared with previously stored unacceptable content, e.g. string data, so as to determine whether the document includes unacceptable content. In the event that no match is determined, e.g. no unacceptable content is detected by the controller 108 or other suitable component associated with the document processing device 104, the requested document processing operation is performed on the received electronic document.

When the controller 108 or other suitable component associated with the document processing device 104 determines that unacceptable content is present in the received electronic document, administrative settings are retrieved from the associated data storage device 110. In accordance with one embodiment of the subject application, the administrative settings correspond to actions to be undertaken by the controller 108 on the unacceptable content of a received electronic document. The controller 108 then determines the appropriate action to be performed on the received electronic document in accordance with the retrieved administrative settings. For example and without limitation, suitable administrative actions include blocking output of the document, blocking output of individual pages of the document containing unacceptable content, replacing pages having unacceptable content with preselected warning pages, replacing unacceptable content with preselected overlays, removal of unacceptable content from the document, e.g. deletion of such content, or the like.

When the administrative settings indicate that an electronic document having unacceptable content is not to be output by the document processing device 104, the electronic document is not output by the document processing device 104, and the user is prevented from making a copy, printing, faxing, or electronically transmitting the received document. When the administrative settings indicate that only pages of the received document having unacceptable content are to be blocked, the controller 108 or other suitable component associated with the document processing device 104 identifies those pages having unacceptable content. The identified pages are thereafter removed from the electronic document, resulting in an altered electronic document. For example, when a document contains proprietary or confidential information, the controller 108 or other suitable component associated with the document processing device 104 removes those pages containing the unacceptable content, i.e. the confidential information, from the received electronic document. Indicia are then generated corresponding to the altered electronic document by the controller 108 via the user interface 106. It will be appreciated by those skilled in the art that a user, via the user device 114, is also capable of displaying the generated indicia of the altered document. Preferably, the user is presented with a graphical representation of the altered document via the user interface 106 for approval thereof. Upon user acceptance of the altered document, the document processing device 104 performs the requested document processing operation on the altered electronic document.

When replacement of pages is dictated by the administrative settings, a warning page is generated by the controller 108 or other suitable component associated with the document processing device 104 depicting a warning to the user that the page being replaced contained unacceptable content. The pages having unacceptable content are thereafter replaced with the generated warning pages and an altered electronic document is thereby generated. Indicia is then generated via the user interface 106 corresponding to the altered document, e.g., the document with warning pages in place of the original pages having unacceptable content. Upon user approval of the altered document, the document processing device 104 performs the requested document processing operation on the altered electronic document.

When the administrative settings indicate that unacceptable content is to be replaced with predefined images or text, e.g. overlay, the controller 108 or other suitable component associated with the document processing device 104 receives overlay data from the associated data storage device 110. It will be appreciated by those skilled in the art that such overlay data is capable of including, for example and without limitation, acceptable images, acceptable language substitutions, or the like. The unacceptable content is then masked with the received overlay data so as to generate an altered electronic document with the unacceptable content suitably covered with acceptable content. Indicia are then generated corresponding to the altered document. Preferably, the user is presented with a graphical representation of the altered document via the user interface 106 for approval thereof. The document processing device 104 then performs the requested document processing operation on the altered electronic document.

When the administrative settings are determined to indicate the removal of unacceptable content, the controller 108 or other suitable component associated with the document processing device 104 removes such content from the electronic document. That is, the unacceptable content is deleted from the electronic document, resulting in an altered electronic document. Indicia are then generated via the user interface 106 corresponding to the altered electronic document, whereupon, the document processing device 104 performs the requested document processing operation on the altered electronic document.

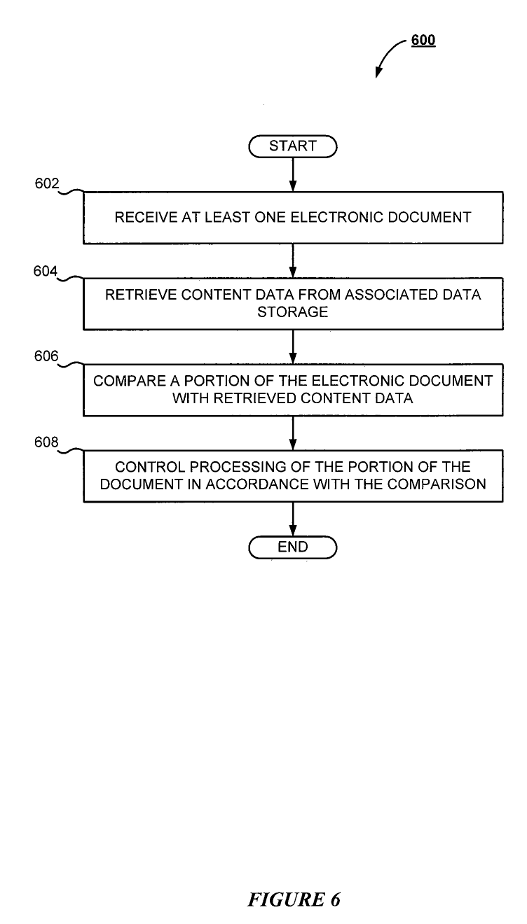

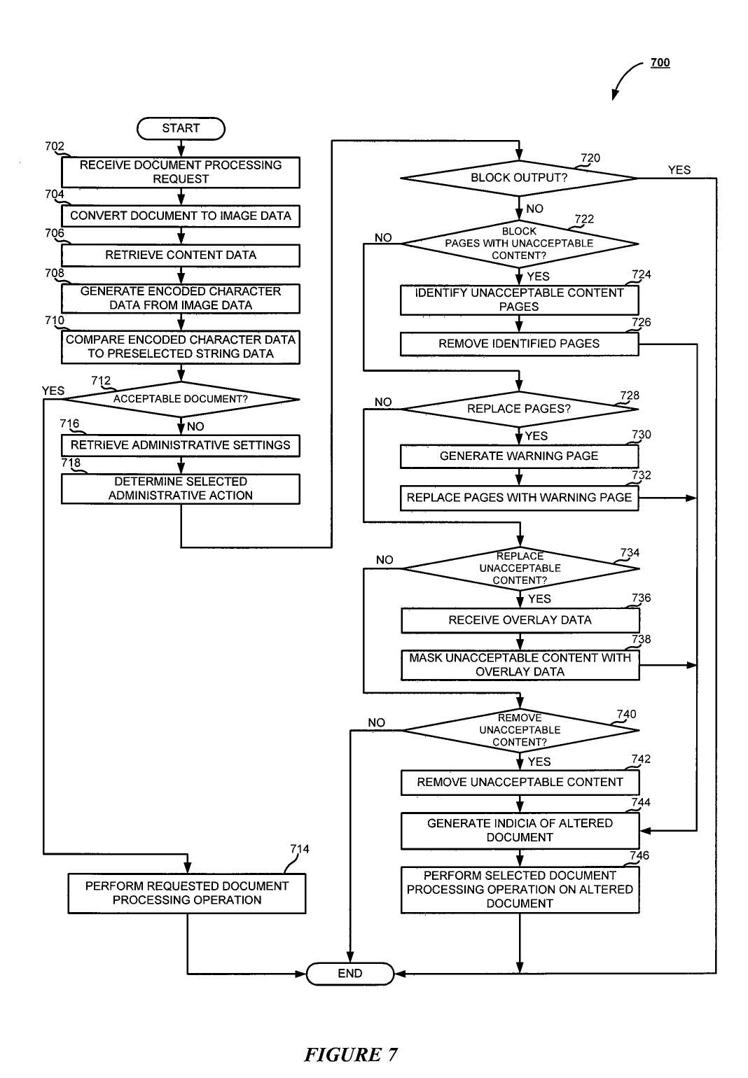

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for content-sensitive document processing in accordance with one embodiment of the subject application. Beginning at step 602, at least one electronic document is received by the document processing device 104. The skilled artisan will appreciate that the received electronic document is capable of including, for example and without limitation, images, photographs, text, or any such combination thereof.

Content data is then retrieved at step 604 from an associated data storage, e.g. the data storage device 110. In accordance with one embodiment of the subject application, the content data corresponds to acceptable content associated with the document processing device 104. That is, the content data indicates the type of content that is acceptable for processing by the document processing device 104. In accordance with one embodiment of the subject application, the content data indicates the type of content that is not acceptable for processing by the document processing device 104, e.g. confidential information, proprietary data, pornography, violent images or text, profanity, immoral or illegal images or text, or a combination thereof. At step 606, a portion of the at least one electronic document is compared with the received content data. Processing of the document processing device 104 is then controlled, at step 608, in accordance with the output of the comparison performed at step 606.

Referring now to FIG. 7, there is shown a flowchart 700 illustrating a method for content-sensitive document processing in accordance with one embodiment of the subject application. The methodology depicted in FIG. 7 begins at step 702, whereupon a document processing request is received by the document processing device 104. It will be appreciated by those skilled in the art that receipt of the electronic document by the document processing device 104 is capable of being accomplished, for example and without limitation, via access to a portable storage media, an electronic transmission from the user device 114, execution of a scanning operation by the document processing device 104, or the like. In accordance with one embodiment of the subject application, the received electronic document is capable of including, for example and without limitation, text, graphics, images, photographs, or any suitable combination thereof, as will be appreciated by the skilled artisan. It will be appreciated by those skilled in the art that while the example implementation of FIG. 7 is described with respect to operations of the controller 108 associated with the document processing device 104, the user device 114 is also capable of being implemented so as to provide user-based interaction in accordance with the method discussed herein.

The received electronic document is then converted, at step 704, to image data. Those skilled in the art will appreciate that the conversion of the electronic document to image data is shown in FIG. 7 for example purposes only, and operation of the subject application is not limited to implementation of this step. For example, conversion to image data would not be necessary when the electronic document received by the document processing device 104 is image data, e.g. a photograph. That is, the received electronic document includes encoded image data, which would not require conversion as set forth in step 704.

At step 706, the controller 108 or other suitable component associated with the document processing device 104 retrieves content data from an electronic database stored on the associated data storage device 110. Preferably, the database of the data storage device 110 includes preselected content, as stipulated by an associated administrator, which corresponds to words and images, i.e. content data, that are unsuitable for the environment in which the document processing device 104 is located, e.g. middle school, high school, library, office, etc., that are stored in a database on the data storage device 110 coupled to the document processing device 104. In accordance with one particular embodiment of the subject application, the administrator sets acceptable and unacceptable content contained in electronic documents associated with the document processing device 104. That is, the administrator determines the type of content, e.g. proprietary data, confidential information, pornography, violence, profanity, immoral, illegal, or other such content, that is to be restricted, i.e. deemed unacceptable, and the content that is acceptable. In accordance with one embodiment of the subject application, the type of content of the electronic document is used to determine whether or not the document processing device 104 is capable of performing a requested document processing operation on a received electronic document. It will be appreciated by those skilled in the art that the content data is capable of including, for example and without limitation, preselected string data, or the like.

At step 708, the controller 108 or other suitable component associated with the document processing device 104 generates encoded character data from the image data associated with the received electronic document. It will be appreciated by those skilled in the art. that the generation of the encoded character data is accomplished via the implementation of optical character recognition on the image data. The controller 108 or other suitable component associated with the document processing device 104 then compares, at step 710, the encoded character data with the retrieved content data, e.g. preselected string data (words, images, descriptions, and the like). In accordance with one embodiment of the subject application, each word and/or image in the document, as embodied by the encoded character data, is compared with previously stored unacceptable content, e.g. string data.

A determination is then made at step 712 whether the received electronic document is acceptable, i.e. whether the document includes unacceptable content. When no unacceptable content is detected, operations proceed to step 714, whereupon the document processing device 104 performs the requested document processing operation on the received electronic document. When unacceptable content is detected, flow proceeds to step 716, whereupon administrative settings are retrieved from the data storage device 110 corresponding to actions to be taken by the document processing device 104 with respect to document processing operations on the associated electronic document. For example and without limitation, suitable administrative actions include blocking output of the document, blocking output of individual pages of the document containing unacceptable content, replacing pages having unacceptable content with preselected warning pages, replacing unacceptable content with preselected overlays, removal of unacceptable content from the document, e.g. deletion of such content, or the like. At step 718, the controller 108 or other suitable component associated with the document processing device 104 then determines the appropriate action to be performed on the received electronic document in accordance with the retrieved administrative settings.

A determination is then made at step 720 whether output of the electronic document having unacceptable content is to be blocked in accordance with the retrieved administrative settings. When the administrative settings indicate that an electronic document having unacceptable content is not to be output by the document processing device 104, the electronic document is not output by the document processing device 104, and the user is prevented from making a copy, printing, faxing, or electronically transmitting the received document. Operations of FIG. 7 thereafter terminate with respect to the received document processing request.

When blocking of the entire electronic document is not warranted, as determined at step 720, flow proceeds to step 722. At step 722, a determination is made whether only those pages containing unacceptable content are to be blocked. Upon a determination that the administrative settings indicate that only pages of the received document having unacceptable content are to be blocked at step 722, flow proceeds to step 724. At step 724, the pages having unacceptable content are identified by the controller 108 or other suitable component associated with the document processing device 104. The controller 108 or other suitable component associated with the document processing device 104 then removes, at step 726, those pages identified as containing unacceptable content. Flow then proceeds to step 744, whereupon the controller 108 or other suitable component associated with the document processing device 104 generates indicia corresponding to the electronic document as altered by the removal of the identified pages. Preferably, the user is presented with a graphical representation of the altered document via the user interface 106 for approval thereof. It will be appreciated by those skilled in the art that a user, via the user device 114, is also capable of displaying the generated indicia of the altered document. Upon user acceptance of the altered document, the document processing device 104 performs the requested document processing operation on the altered electronic document at step 746.

Returning to step 722, when it is determined that the administrative settings do not dictate the blocking of pages containing unacceptable content, flow proceeds to step 728. At step 728, a determination is made whether the administrative settings direct the replacement of pages having unacceptable content with warning pages. A positive determination at step 728 prompts the generation of a warning page indicating that the page the warning page replaces contained unacceptable content at step 730. The pages having unacceptable content are thereafter replaced, at step 732, with the generated warning pages via operations of the controller 108 or other suitable component associated with the document processing device 104, resulting in an altered electronic document. For example, when a page contains violent content, a warning page displaying a message “Warning, this page contains violent content” is used to replace the original page. Similarly, when the page contains proprietary content, a warning page is generated displaying a message “Warning, this page contains proprietary data” and replaces the original page containing the proprietary data. Operations then proceed to step 744, whereupon the controller 108 or other suitable component associated with the document processing device 104 generates indicia corresponding to the altered electronic document via the user interface 106, e.g., a graphical representation of the document with warning pages in place of the original pages having unacceptable content. Thereafter, the document processing device 104 performs the requested document processing operation on the altered electronic document at step 746.

When it is determined at step 728 that the administrative settings do not require that pages having unacceptable content be replaced with warning pages, flow proceeds to step 734. At step 734, a determination is made whether to replace the unacceptable content, e.g. the unacceptable text and/or images, with preselected overlay data. That is, whether or not the administrative settings indicate that the unacceptable content is to be replaced word for word and/or image for image with preselected overlay words and/or images. Upon a positive determination at step 734, flow proceeds to step 736, whereupon overlay data is received from the associated data storage device 110 by the controller 108 or other suitable component associated with the document processing device 104. It will be appreciated by those skilled in the art that such overlay data is capable of including, for example and without limitation, acceptable images, acceptable language substitutions, or the like. At step 738, the controller 108 or other suitable component associated with the document processing device 104 then masks the unacceptable content with the received overlay data, resulting in an altered electronic document. Flow then proceeds to step 744, whereupon indicia are generated by the controller 108 or other suitable component associated with the document processing device 104 corresponding to the altered electronic document. The document processing device 104 then performs the requested document processing operation on the altered electronic document at step 746.

Upon a determination at step 734 that the unacceptable content is not to be replaced with preselected overlay data, flow progresses to step 740. At step 740, a determination is made whether or not the administrative settings are determined to indicate the removal of unacceptable content. When such a determination is made at step 740, flow progresses to step 742, whereupon the unacceptable content is removed from the electronic document by the controller 108 or other suitable component associated with the document processing device 104. That is, the unacceptable content is deleted from the electronic document, resulting in an altered electronic document. The controller 108 or other suitable component associated with the document processing device 104 then generates, at step 744, indicia via the user interface 106 corresponding to the altered electronic document. At step 746, the document processing device 104 performs the requested document processing operation on the altered electronic document. In the event that the determination made at step 740 indicates that the unacceptable content is not to be removed, operations terminate with no document being output by the document processing device 104.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A content-sensitive document processing system comprising:
means adapted for receiving at least one electronic document;
means adapted for retrieving content data from an associated data storage, which content data corresponds to acceptable content associated with at least one document processing device;
comparison means adapted for comparing at least a portion of the at least one electronic document with received content data; and
control means adapted for controlling processing of at least a portion of a received electronic document by the document processing device in accordance with an output of the comparison means.

2. The system of claim 1 further comprising means adapted for masking at least a portion of the received electronic document by the document processing device in accordance with an output of the control means.

3. The system of claim 2 further comprising:
means adapted for receiving overlay data; and
wherein the masking means includes means adapted for masking the at least a portion of the received electronic document with received overlay data.

4. The system of claim 3 wherein the overlay data includes data adapted for generating indicia representative of altered document processing.

5. The system of claim 1 wherein the electronic document includes encoded image data and the content data includes preselected string data, and wherein the system further comprises:
optical character recognition means adapted for generating encoded character data from received image data; and wherein
the comparison means includes means adapted for comparing encoded character data with the preselected string data.

6. The system of claim 1 wherein the electronic document includes encoded image data, and wherein the content data includes data corresponding to acceptability of encoded image data.

7. A content-sensitive document processing method comprising the steps of:
receiving at least one electronic document;
retrieving content data from an associated data storage, which content data corresponds to acceptable content associated with at least one document processing device;
comparing at least a portion of the at least one electronic document with received content data; and
controlling processing of at least a portion of a received electronic document by the document processing device in accordance with an output of the comparison step.

8. The method of claim 7 further comprising the step of masking at least a portion of the received electronic document by the document processing device in accordance with an output of the controlling step.

9. The method of claim 8 further comprising the step of:
receiving overlay data; and
wherein the masking at least a portion of the received electronic document is with received overlay data.

10. The method of claim 9 wherein the overlay data includes data adapted for generating indicia representative of altered document processing.

11. The method of claim 7 wherein the electronic document includes encoded image data and the content data includes preselected string data, and wherein the method further comprises the step of:
generating encoded character data from received image data; and wherein
the comparison of encoded character data is with the preselected string data.

12. The method of claim 7 wherein the electronic document includes encoded image data, and wherein the content data includes data corresponding to acceptability of encoded image data.
